(19) United States
(12) Patent Application Publication
(10) Pub. No.: US 2026/0017444 A1
(43) Pub. Date: Jan. 15, 2026

(54) METHOD FOR COMMUNICATING WITH A COMPUTER DEVICE COMPRISING A KNOWLEDGE DATABASE

(71) Applicant: Orange, Issy-les-Moulineaux (FR)

(72) Inventors: Yoan Chabot, CHATILLON CEDEX (FR); Fréderic Deuze, CHATILLON CEDEX (FR)

(21) Appl. No.: 19/263,267

(22) Filed: Jul. 8, 2025

(30) Foreign Application Priority Data
Jul. 9, 2024 (FR) 2407457

(51) Int. Cl. G06F 40/12; G06F 40/40

(52) U.S. Cl. CPC G06F 40/12; G06F 40/40

(57) ABSTRACT

A method is described for communicating with a computer device comprising a knowledge database modelling data in the form of a knowledge graph. The method includes, on the device, receiving a first request comprising information relating to an entity of the knowledge graph; commanding the rendering of a web page containing this information; receiving a second request requesting at least one missing property of said entity, from among said rendered information; commanding the rendering of a web page containing a list of missing properties classified by the observation frequency of these properties for other entities of the same type; polling a language model, based on a prompt generated by said device in natural language, with said prompt asking the language model for the value of at least one of the properties in the list; and commanding the rendering of a web page containing that value.

### INCORPORATION BY REFERENCE TO ANY PRIORITY APPLICATIONS

The disclosed technology relates Any and all applications for which a foreign or domestic priority claim is identified in the Application Data Sheet as filed with the present application are hereby incorporated by reference under 37 CFR 1.57.

### TECHNICAL FIELD

The disclosed technology relates to polling databases. More specifically, the present disclosed technology relates to a method for communicating with a computer device (computer, server, platform, etc.) comprising a knowledge database modelling data in the form of a knowledge graph, for the purpose of enriching the information contained in the knowledge graph. The disclosed technology also relates to the corresponding computer device, computer program and storage medium.

### BACKGROUND

Among the techniques for constructing knowledge graphs, collaborative construction involving human contributors remains important, as exemplified by the Wikidata knowledge graph, which is a reference for many fields and use cases. This collaborative construction is currently mainly carried out manually, which makes the work of constructing the graph long and tedious, particularly when the fields of knowledge are vast. In addition, the information in the knowledge graph resulting from this manual construction may not always be reliable and legitimate.

Techniques also exist for enriching knowledge graphs using generative artificial intelligence systems such as large language models. Language models are polled using a prompt in order to retrieve missing knowledge in a knowledge graph for an entity in the knowledge graph that is to be enriched. However, such a technique involves sending requests to the language model in all directions, without any preconceptions concerning the desirable properties for the entity to be enriched. The use of language models when implementing such a technique is therefore very costly because it requires numerous inferences in order to generate missing properties that are not necessarily relevant to the entity to be enriched. As a result, the information that enriches the knowledge graph is sometimes inaccurate and inconsistent, which significantly undermines the reliability of this enrichment technique.

### SUMMARY

One of the aims of the disclosed technology is to overcome at least one of the disadvantages of the aforementioned approaches by proposing a new technique for enriching a knowledge graph that is more efficient, particularly in terms of computational resource costs and energy consumption, and reduces hallucinations.

To this end, one aim of the disclosed technology relates to a method for communicating with a computer device comprising a knowledge database modelling data in the form of a knowledge graph, said method comprising the following, on said device:
receiving a first request comprising information relating to an entity of the knowledge graph;
commanding the rendering of a web page containing said information;
receiving a second request requesting at least one missing property of said entity, from among said rendered information;
commanding the rendering of a web page containing a list of missing properties classified by the observation frequency of these properties for other entities of the same type;
polling a language model, based on a prompt generated by the device in natural language, with the prompt asking the language model for the value of at least one of the properties in the list;
commanding the rendering of a web page containing this value.

The disclosed technology allows, during the phase of enriching a knowledge graph, the computer device to automatically generate one or more appropriate and targeted prompts for a language model, with such prompts only being generated in relation to missing properties that have been previously identified as being relevant to the entity, thus limiting the risks of hallucinations with respect to properties that are not relevant for this entity. By virtue of the use of such a language model:
the number of human operations for enriching a knowledge graph is significantly reduced compared to other solutions for collaborative enrichment of the knowledge graphs, thereby reducing the errors that can occur during enrichment, alleviating the task for users and accelerating the enrichment phase;
the number of inferences generated by the computer system in order to generate properties is significantly reduced, which, in the case of some solutions based on generative AI tools, are not necessarily relevant to the entity to be enriched because they result from sending numerous queries without any prior knowledge of the desirable properties for the entity to be enriched.

The disclosed technology thus allows a technique for enriching a knowledge graph to be proposed that is more efficient because it is faster, less expensive, and less energy-intensive than the conventional techniques for enriching knowledge graphs.

According to a specific embodiment, the prompt is generated for a number of properties in the list that is determined with respect to a threshold for the observation frequency of these properties in the knowledge database, for at least one other entity of the same type as the entity.

Given that the prompts are generated for a number of properties that is determined in relation to a required observation frequency threshold, the language model is thus used in a more limited manner, since fewer prompts will be generated by the computer device, which optimizes the reduction in the energy footprint and the cost of the enrichment technique of the disclosed technology.

According to another specific embodiment, the observation frequency threshold is defined before implementing the communication method or is contained in a third request received by the device, in response to the rendering of the web page containing the list of missing properties.

Such an embodiment allows a knowledge graph to be enriched by a user of the computer device in an adaptive and customizable manner.

According to another specific embodiment, the communication method comprises the following:
receiving a selection of a validation or non-validation of said value contained in the web page rendered using a human-machine interface;
adding said value to the knowledge graph, in association with said entity, if validation of the value is requested.

Such an embodiment allows a user of the computer device to be offered a simplified enrichment interface that greatly facilitates the manual operations for enriching a knowledge graph.

According to another specific embodiment, said value relates to a data property or to an object property.

Such an embodiment allows the knowledge graph to be enriched with different types of data, which allows a knowledge graph to be enriched in a precise and complete manner.

The various aforementioned embodiments or features can be added to the communication method as defined above independently or in combination with each other.

The disclosed technology also relates to a computer device comprising a knowledge database modelling data in the form of a knowledge graph, the device being characterized in that it is configured to implement:
receiving a first request comprising information relating to an entity of the knowledge graph;
commanding the rendering of a web page containing said information;
receiving a second request requesting at least one missing property of said entity, from among said rendered information;
commanding the rendering of a web page containing a list of missing properties classified by the observation frequency of these properties for other entities of the same type;
polling a language model, based on a prompt generated by said device in natural language, with said prompt asking the language model for the value of at least one of the properties in the list;
commanding the rendering of a web page containing said value.

Such a device is notably configured to implement the aforementioned communication method, according to any of the embodiments thereof.

The disclosed technology also relates to a computer program comprising instructions for implementing the communication method according to the disclosed technology, according to any one of the specific embodiments described above, when said program is executed by a processor.

Such instructions can be permanently stored in a non-transitory memory medium of the computer device implementing the communication method according to the disclosed technology.

This program can use any programming language and can be in the form of source code, of object code, or of intermediate code between source code and object code, such as in a partially compiled format, or in any other desirable format.

The disclosed technology also relates to a computer-readable storage medium or information medium comprising instructions of a computer program as mentioned above.

The storage medium can be any entity or device capable of storing the program. For example, the medium can comprise a storage medium, such as a ROM, for example, a CD-ROM or a microelectronic circuit ROM, or even a magnetic storage medium, for example, a movable medium, a hard disk or an SSD.

Moreover, the storage medium can be a transmissible medium such as an electrical or optical signal, which can be routed via an electrical or optical cable, by radio or by other means, so that the computer program it contains can be executed remotely.

The program according to the disclosed technology particularly can be downloaded from a network, for example, an Internet-type network.

Alternatively, the storage medium can be an integrated circuit incorporating the program, with the circuit being adapted to execute or to be used to execute the aforementioned communication method.

According to one embodiment, the present technique is implemented by means of software and/or hardware components. In this context, the term “device” or “module” in this document can equally refer to a software component, to a hardware component or to a set of hardware and software components.

### BRIEF DESCRIPTION OF THE DRAWINGS

Further features and advantages will become apparent from reading specific embodiments of the disclosed technology, which are provided by way of illustrative and non-limiting examples, and with reference to the appended drawings, in which:

FIG. 1 shows an architecture in which the communication method is implemented, according to a specific embodiment of the disclosed technology;

FIG. 2 shows a computer device according to a specific embodiment of the disclosed technology, as implemented in the architecture of FIG. 1;

FIG. 3A shows the main actions implemented in the communication method, according to a specific embodiment of the disclosed technology, as implemented in the architecture of FIG. 1;

FIG. 3B shows the main actions implemented in the communication method, according to a specific embodiment of the disclosed technology, as implemented in the architecture of FIG. 1;

FIG. 4 shows an example of a web page generated when implementing the communication method, according to a specific embodiment of the disclosed technology;

FIG. 5 shows an example of a web page generated when implementing the communication method, according to a specific embodiment of the disclosed technology;

FIG. 6 shows the main actions implemented during a data enrichment phase of the communication method, according to a specific embodiment of the disclosed technology, as implemented in the architecture of FIG. 1.

### DETAILED DESCRIPTION

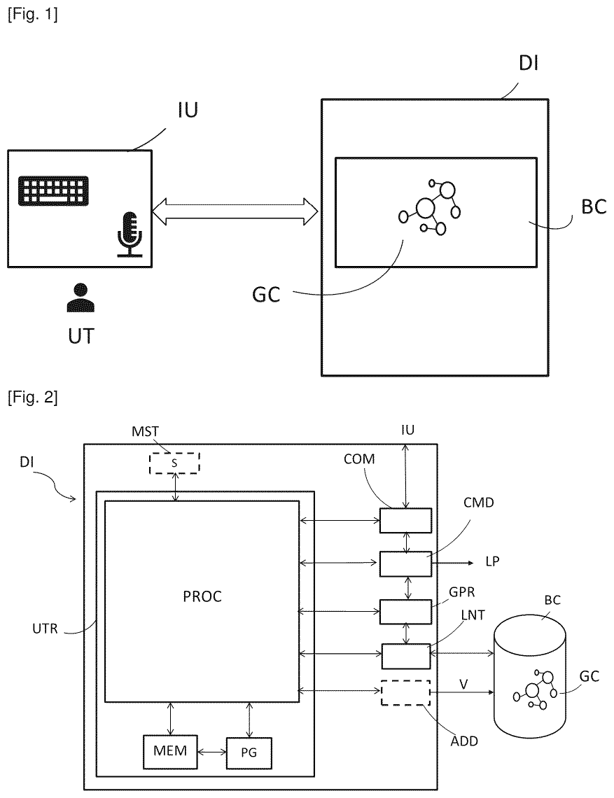

FIG. 1 shows an architecture in which a communication method is implemented, according to one embodiment of the disclosed technology.

Such an architecture comprises:
a computer device DI comprising a knowledge database BC modelling data in the form of a knowledge graph GC;
a human-machine interface IU configured to be activated by a user UT in order to communicate with the computer device DI.

The computer device DI can comprise, for example, a computer, a server, a platform, etc.

In FIG. 1, the knowledge database BC is integrated into the computer device DI. Of course, such a knowledge database BC can be separate from the computer device DI, with said computer device then being configured to communicate with the knowledge database BC using any suitable communication means.

The interface IU can comprise, for example, a text-based graphical interface or a sound sensor coupled to a voice recognition interface. Such an interface can form part of the computer device DI or can be separate from said device. The knowledge graph GC is, for example, of the Wikidata, DBpedia, Google Knowledge Graph, Microsoft Concept Graph type, etc.

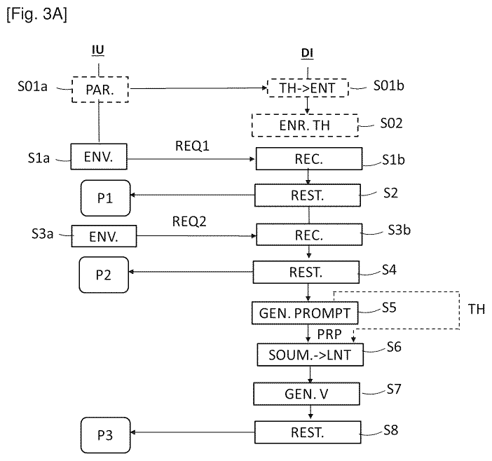

The simplified structure of the computer device DI will now be described with reference to FIG. 2.

According to the disclosed technology, the computer device DI comprises:
a communication module COM configured to receive requests generated using the interface UI;
a command module CMD configured to command the rendering of responses to the generated requests;
a prompt generation module GPR configured to generate a prompt in natural language;
a natural language model LNT configured to be polled from the generated prompt.

Such a natural language model can be, for example, an n-gram model, a recurrent neural network RNN, a large language model LLM, etc. The natural language model LNT has been conventionally trained to garner knowledge.

According to the disclosed technology:
the communication module COM is configured to notably receive a request REQ1 generated using the interface IU, with said request including information relating to an entity in the knowledge graph GC.

An entity can be, for example, the name of an object, a person, a company, etc.;
the command module CMD is notably configured to command the rendering of a web page including the information requested in the request REQ1.

Also, according to the disclosed technology:
the communication module COM is configured to notably receive a request REQ2 generated using the interface IU, with the request REQ2 requesting at least one missing or desirable property of said entity from among the rendered information;
the command module CMD is notably configured to control the rendering of a web page containing a list LP of missing properties classified by the observation frequency of these properties for other entities of the same type as said entity.

The information relating to the entity that is contained in the request REQ1 can include, in natural language, the name of the entity manually entered or spoken by the user UT via the interface IU. Alternatively, the request REQ1 can be written in a computer language, for example, of the SQL (Structured Request Language), Python type, etc.

According to the disclosed technology:
the prompt generation module GPR is configured to automatically generate, i.e., without the intervention of the user UT, a prompt requesting the value of at least one of the missing properties from the list LP that was rendered using the command module CMD;
the natural language model LNT is configured to be polled based on this generated prompt;
the command module CMD is notably configured to command the rendering of a web page containing a value V of said at least one missing property.

Optionally, according to the disclosed technology, the communication module COM is configured to receive, in response to the rendering of a web page containing a list LP of missing properties classified by the observation frequency of these properties for other entities of the same type as said entity, a request REQ3 generated using the interface IU, with said request REQ3 containing an observation frequency threshold for these properties in the knowledge database.

Optionally, according to the disclosed technology, the computer device DI can comprise a storage module MST that stores a threshold TH for the observation frequency of the missing properties in the knowledge database BC. As such a storage module MST is optional, it is shown as dashed lines in FIG. 2.

According to the disclosed technology, the computer device DI can comprise an addition module ADD that is configured to add the value V of said at least one missing property to the knowledge graph GC. As the module ADD is optional, it is shown as dashed lines in FIG. 2.

According to the disclosed technology, the communication module COM can be configured to notably receive a request REQ4 requesting the validation or non-validation of the value of said at least one missing property.

Upon initialization, the code instructions of the computer program PG are loaded, for example, into a RAM (not shown) before being executed by the processor PROC.

The processor PROC of the processing unit UTR notably implements the following actions, within the context of the communication method to be described below, according to the instructions of the computer program PG:
receiving the request REQ1 including information relating to an entity in the knowledge graph;
commanding the rendering of a web page containing said information;
receiving the request REQ2 requesting at least one missing property of said entity from among said rendered information;
commanding the rendering of a web page containing a list of missing properties classified by the observation frequency of these properties for other entities of the same type;
polling the language model LNT based on the prompt generated in natural language, with said prompt asking the language model for the value V of at least one of the properties in the list;
commanding the rendering of a web page containing said value V;
optionally adding the value V of said at least one missing property to the knowledge graph GC;
optionally receiving the request REQ3 containing an observation frequency threshold for the missing properties in the knowledge database;
optionally storing the observation frequency threshold TH for the missing properties in the knowledge database BC;
optionally receiving the request REQ4 requesting the validation or non-validation of the value of said at least one missing property.

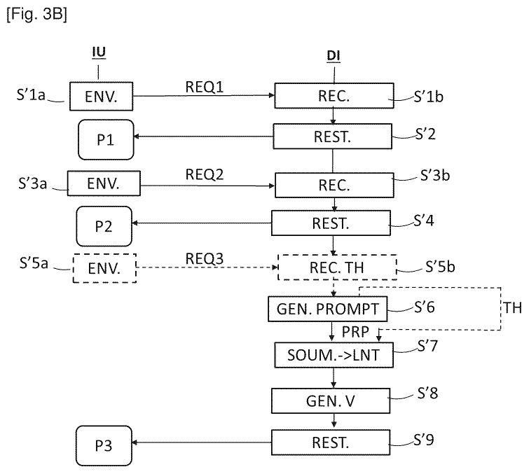

The sequence of steps in a communication method with the computer device DI, according to a first specific embodiment of the disclosed technology, will now be described with reference to FIG. 3A, together with FIGS. 1 and 2.

During an optional preliminary step S01, the user UT configures the computer device DI by setting, for an entity ENT of the knowledge graph GC searched for by the user UT, an observation frequency threshold TH for the missing properties of this entity in the knowledge database BC, for at least one other entity of the same type as this entity. To this end, using the user interface IU, the user UT enters the threshold TH, for example, 50%, or vocalizes the threshold TH.

During an optional preliminary step S02, the threshold TH is stored in the memory MST of the computer device DI.

Since steps S01 and S02 are optional, they are shown as dashed lines in FIG. 3A. During a step S1a, the user UT sends a request REQ1 to the knowledge graph GC via the interface IU, with said request REQ1 including information relating to the entity ENT of the knowledge graph GC. This request is received in step S1b by the computer device DI via its module COM.

The information contained in the request REQ1 can include one or more words. Such a request can be written in natural language or in a specific computer language, for example, of the SQL (Structured Request Language), Python type, etc.

In one embodiment, the request REQ1 includes the word “iPhone 6S”, designating the “iPhone 6S” entity ENT.

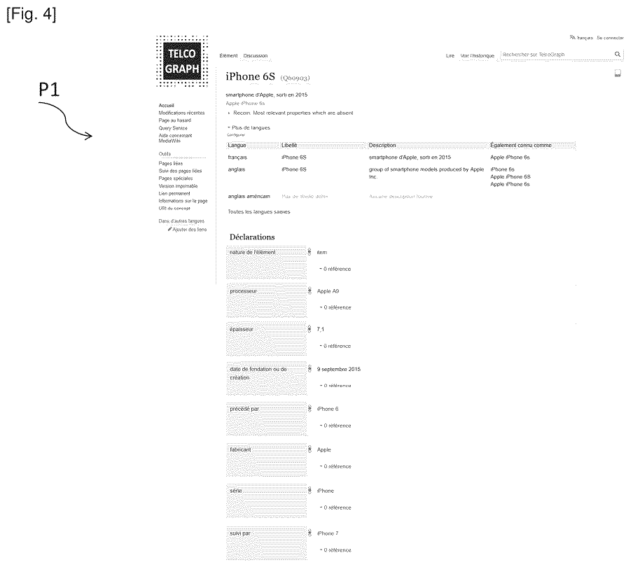

During a step S2, the command module CMD of the computer device DI commands the rendering of a web page P1 containing information relating to the requested entity ENT. In the example shown in FIG. 4, the web page P1 contains information relating to the “iPhone 6S” entity, which contains a unique identifier within the knowledge graph GC, namely, Q60903, in the example shown. Several knowledge triples relate to this entity. A knowledge triplet is a set of three elements <subject, property, object>. In the example in FIG. 4, <iPhone 6S (Q60903), processor, Apple A9> is a knowledge triplet linking a subject “iPhone 6S”, a property “processor” and an object “Apple A9”. Subsequently, two types of properties are distinguished:
object properties linking one entity to another via a property. For example, the “processor” property is an object property linking the “iPhone 6S” entity to the “Apple A9” entity, which itself is represented by a unique identifier in the knowledge graph GC;
the data properties linking an entity to a value via a property. For example, the “thickness” property is a data property assigning the value 7.1 to the “iPhone 6S” entity. The values can assume different types: numerical, date, character string, etc.

During a step S3a, the user UT sends a request REQ2 to the knowledge graph GC via the user interface IU, with said request REQ2 requesting at least one missing property of the entity ENT from said information rendered in S2. This request is received in step S3b by the computer device DI via its module COM.

In a manner known per se, the user UT activates a knowledge graph analysis tool which, for a given entity, computes a completeness rate for the entity relative to entities of the same type (in the semantic sense in the knowledge graph) and identifies the missing properties commonly observed for this type. The type of entity in this case refers to a knowledge triplet that allows the entity to be “classified” into one or more semantic categories via a specific typing property, for example, “nature of the element” in FIG. 4. The “nature of the element” property in FIG. 4 links the “iPhone 6S” entity to the “item” type. The “iPhone 6S” entity also could have been typed with the “mobile phone” entity, for example.

An example of such a tool is, for example, the RECOIN extension (www.wikidata.org/wiki/Wikidata: Recoin) for Wikidata, which allows, using computations of the frequencies of the occurrence of the properties, desirable or missing properties to be listed for a given entity.

Another example of such a tool is the Wiki2Prop tool described in the paper entitled, “Wiki2Prop: A Multimodal Approach for Predicting Wikidata Properties from Wikipedia”, WWW '21: The Web Conference 2021, Virtual Event/Ljubljana, Slovenia, 19-23 Apr. 2021, which allows new properties to be proposed for an entity based on its associated Wikipedia page. As described in this document, the desirable properties for an entity are identified using an analysis of the knowledge graph. Given an entity and its type (encoded in the knowledge graph), the tool computes the frequencies of the properties instantiated and observed on the entities of the same type in the knowledge graph. Based on this computation, the tool outputs a completeness rate for the entity compared to entities of the same type, as well as a list of properties ranked by the observation frequency in other entities of the same type.

During a step S4, the command module CMD of the computer device DI commands the rendering of a web page P2 containing a list of missing properties ranked by the observation frequency of these properties for other entities of the same type, ranging from 60% to 10% in the example shown.

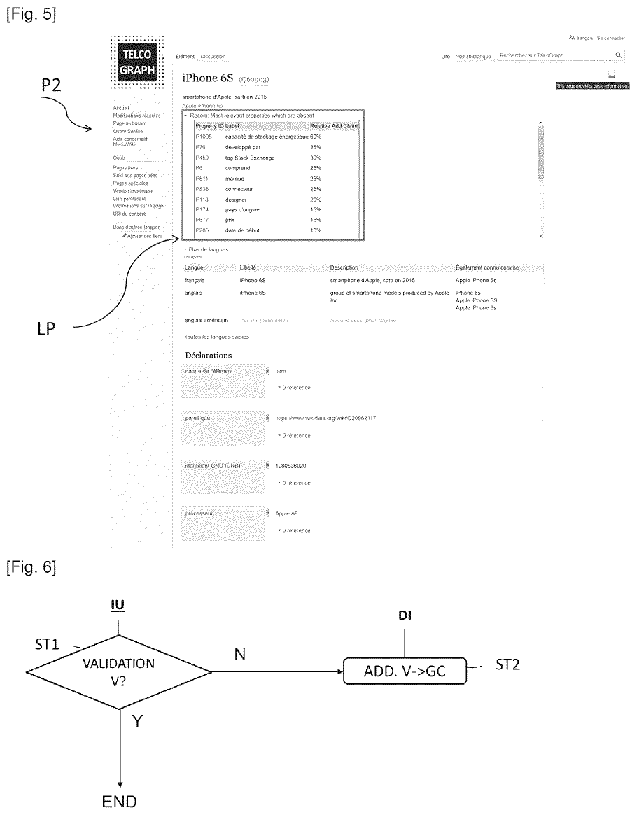

An example of such a web page P2 is shown in FIG. 5, in the case of the “iPhone 6S” entity. In the example shown, a list LP of ten missing properties is generated, with each property in this list being associated with an identifier ID in the knowledge graph and an estimated observation frequency as a percentage.

Of course, this example is not exhaustive. In another example, not shown, depending on the entity to be searched for in the knowledge graph GC, a single property could be generated in association with its identification ID and its observation frequency.

During a step S5, the prompt generation module GPR automatically generates a prompt PRP requesting the value of at least one of the properties in the list that was rendered in the web page P2. Such a prompt PRP is, for example, a natural language sentence, such as: “What is the value of the DESIRABLE PROPERTY property for the ENT TO BE COMPLETED entity? Only provide the value found.” More contextual information can be added to the prompt PRP as “context” for guiding the generation of data by the language model LNT. Such contextual information can be added, for example, using a well-known method called “prompt engineering”. This is a method for enriching and structuring the prompt in order to increase the accuracy and the quality of the results provided by the language model LNT. In the example shown in FIGS. 4 and 5, it is possible to contemplate, for example, giving more context to the language model LNT by inserting fragments of text documents into the prompt PRP by way of context that deal with the “iPhone 6S” subject. It is also possible to contemplate, for example, manually adding limitations to the prompt based on the knowledge that the user UT has of the knowledge graph GC. For example, in the case of the “energy storage capacity” property, the user UT can use their prior knowledge about this particular property (knowledge originating from the knowledge graph). If, for example, the target “has a unit of milliampere hour (mAh)” for the “energy storage capacity” property and this has not been encoded in the knowledge graph GC, the user UT could specify, for example, in the prompt PRP that a response with a unit of milliampere hour (mAh) is expected.

During a step S6, the prompt PRP is submitted to the language model LNT, which generates, during a step S7, a corresponding value V for each of the properties in the list LP, 10 values in the example shown in FIG. 5. Depending on the type of missing properties, the generated value V relates to a data property or even a value property. When the generated value relates to a data property, no specific post-processing is required other than formatting in order to comply with the format expected by the knowledge graph GC (for example, a specific date format). For example, in the case of the “energy storage capacity” property, the language model LNT can generate the value V “1715 (mAh)”, which does not require any additional processing to be potentially subsequently added to the knowledge graph GC.

When the generated value relates to an object property, a well-known entity linking step is implemented in order to convert the character string representing an entity ENT into an entity identifier known to the knowledge database BC. For example, if the prompt requests a value V for the “developed by” property illustrated in FIG. 5, the language model LNT could respond with an “Apple” character string. This character string cannot be used as it is because it is ambiguous. Indeed, it is impossible to know whether this character string refers to a fruit, a company name or something else. Furthermore, this character string does not correspond to an entity identifier in the knowledge graph GC. This justifies the need to progress through a step of disambiguation, in other words, to select the correct meaning of the entity in relation to the context, and of entity linking, i.e., finding the identifier in the knowledge graph GC for the entity corresponding to the textual note “Apple”.

During a step S8, the command module CMD of the computer device DI commands the rendering of a web page P3 containing the value V of at least one of the missing properties in the list LP, for example, the one with the highest observation frequency in the list LP. Alternatively, in the example in FIG. 5, the web page P3 can contain the ten values V associated with the ten missing properties, respectively. According to another non-exhaustive example, ten web pages P3, each containing a value V of one of the ten missing properties, can be successively rendered in step S8.

According to one embodiment of the disclosed technology, in the case where steps S01a, S01b and S02 for configuring a threshold TH for the observation frequency have been implemented, the prompt PRP generated in step S5 only requests the values of the missing properties for which the observation frequency is greater than or equal to or strictly greater than the threshold TH, which in the above example is 50%.

With reference to FIG. 5, only the missing property P1008 “Energy storage capacity” exceeds this threshold TH. The prompt PRP generated in step S5 is therefore unique and includes, for example, the natural language sentence: “What is the value of the “Energy storage capacity” property for the “iPhone 6S” entity? Only provide the value found.” The prompt PRP is then submitted, in step S6, to the language model LNT, which generates the value V “1715 (mAh)” in step S7.

A phase of enriching the knowledge graph GC will now be described with reference to FIG. 6, according to one embodiment of the disclosed technology. Such a phase can be implemented at the end of step S8 of rendering the value V, as shown in FIG. 3A.

This enrichment phase comprises:
a step ST1 of the user UT validating or not validating the value V rendered in step S8, using the aforementioned interface IU;
if the value V is validated (O in FIG. 6), a step ST2 in which the value V is added to the knowledge graph GC by the module ADD of the computer device DI, in association with the entity ENT for which the user UT requested information in step S1a of FIG. 3A.

If the value V is not validated (N in FIG. 6), the communication method is terminated. The knowledge graph GC therefore will not be enriched with the value V for the entity ENT.

The sequence of steps of a communication method with the computer device DI will now be described with reference to FIG. 3B, together with FIGS. 1 and 2, according to a second specific embodiment of the disclosed technology.

This second embodiment differs from the first embodiment in that it does not include the optional steps of configuring the thresholds TH S01a, S01b, S02.

This second embodiment provides another optional way of generating a threshold TH for the observation frequency, as will be described below.

Unlike the embodiment of FIG. 3A, where the threshold TH is determined before implementing the communication method, in this second embodiment, the threshold TH can be dynamically and spontaneously determined during the communication method.

The communication method, according to the second embodiment, comprises steps S′1a to S′4 identical to steps S1a to S4 in FIG. 3A. For this reason, they will not be described again.

At the end of step S′4, during an optional step S′5a, the user UT sends a request REQ4 to the computer device DI via the interface IU, with said request REQ4 containing the threshold TH. This request is received in step S′5b by the computer device DI via its module COM.

The following steps, S′6 to S′9, are identical to steps S5 to S8 in FIG. 3A. For this reason, they will not be described again.

At the end of step S′9, the enrichment phase shown in FIG. 6 can be implemented.

The communication method described above notably allows the involvement of human contributors to be limited in terms of feeding a knowledge graph by integrating a generative AI (artificial intelligence) module into the construction chain that is capable of generating new knowledge. Users can thus rely on, through a suitable application, generative artificial intelligence technology for proposing relevant content in order to enrich entities in the knowledge graph. This method also allows the generative AI module to be used sparingly by limiting inference operations, which represent a significant cost from both a financial and environmental standpoint. The disclosed technology is applicable to any field requiring the construction of a knowledge graph.

1. A method for communicating with a computer device comprising a knowledge database modelling data in the form of a knowledge graph, said method comprising, on said device:
receiving a request requesting at least one missing property of an entity in said graph, from among information relating to said entity and previously sent in a web page;
commanding rendering of a web page containing a list of missing properties classified by the observation frequency of these properties for other entities of the same type;
polling a language model, based on a prompt generated by said device in natural language, with said prompt asking the language model for a value of at least one of the properties in the list; and
commanding rendering of a web page containing said value.

2. The method of claim 1, wherein said prompt is generated for a number of properties in said list that is determined with respect to a threshold for an observation frequency of these properties in the knowledge database, for at least one other entity of the same type as said entity.

3. The method of claim 2, wherein said observation frequency threshold is defined before implementing the communication method or is contained in another request received by said device, in response to the rendering of the web page containing the list of missing properties.

4. The method of claim 1, further comprising the following:
receiving a selection of a validation or non-validation of said value contained in the web page rendered using a human-machine interface; and
adding said value to the knowledge graph, in association with said entity, if validation of the value is requested.

5. The method of claim 1, wherein said value relates to a data property or to an object property.

6. A computer device comprising a knowledge database modelling data in the form of a knowledge graph, the device configured to:
receive a request requesting at least one missing property of an entity in said graph, from among information relating to said entity and previously sent in a web page (P1);
command rendering of a web page containing a list of missing properties classified by an observation frequency of these properties for other entities of the same type;
poll a language model, based on a prompt generated by said device in natural language, with said prompt asking the language model for the value of at least one of the properties in the list; and
command rendering of a web page containing said value.

7. A computer comprising a processor and a memory, the memory having stored thereon instructions which, when executed by the processor, cause the computer to implement the method of claim 1.

8. A non-transitory, computer-readable medium having stored thereon instructions which, when executed by a processor, cause the processor to implement the method of claim 1.
